(19) United States
(12) Patent Application Publication
(10) Pub. No.: US 2007/0152791 A1
(43) Pub. Date: Jul. 5, 2007

(54) MAGNETIC ARRAY

(76) Inventors: Seong-Jae Lee, Ames, IA (US); Dennis O'Neel, West Des Moines, IA (US)

Correspondence Address: ZARLEY LAW FIRM P.L.C., CAPITAL SQUARE, 400 LOCUST, SUITE 200, DES MOINES, IA, 50309-2350, US

(21) Appl. No.: 11/306,571

(22) Filed: Jan. 3, 2006

(51) Int. Cl. H01F 7/02

(52) U.S. Cl. 335/306

(57) ABSTRACT

A magnetic array having a collar with a plurality of magnets mounted to the inner surface of the collar. The magnets are positioned in a spaced alignment around the collar with all having the same polarity facing toward the center of the collar. Shielding is used to control and/or contain the direction of the magnetic force and the array is covered with a plastic coating.

### BACKGROUND OF THE INVENTION

This invention is directed to a magnetic array for removing ferrous particles from moving liquids.

When operating devices having moving parts such as vehicle engines, hydraulic pumps, bearings, or the like, friction between the parts occurs that leads to wear. This occurs even in the presence of lubricants. As a result of the friction and wear ferrous metal particles are created including sub-micron, micron, and larger particles. In engines, oil is used as a lubricant and oil filters are used to capture particles from circulating through the system. The internal filter media in an oil filter has an engineered porosity between 20-40 microns to maintain oil pressure. The ferrous metal particles smaller than the filter media porosity circulates in the oil and lead to damage in the device, affecting both the efficiency of the device and the life span. For example, the metal particles are harder than the original surface due to compaction, and as the particles circulate, they cause additional damage as they contact metal surfaces or bury themselves between surfaces and cut into the surface which leads to further damage and possibly system failure.

Prior attempts have been made to solve this problem in the art. As one example, U.S. Pat. No. 5,556,540 by Brunsting teaches a band with a plurality of magnets having alternating polarity mounted to the inner surface of the band. While Brunsting improved upon the prior art, the arrangement of alternating polarity of the magnets causes the magnetic fields from a north-pole magnet to go directly to a south-pole magnet located next to the north-pole magnet. As a result, the range of magnetic force and direction for capturing metal particles becomes short and does not effectively filter metal particles.

Therefore, an objective of the present invention is to provide a magnetic array that has greater magnetic force to attract particles.

A further objective of the present invention is to provide a magnetic array that is more durable and safer to use.

These and other objectives will be apparent to those skilled in the art based on the following written description.

### SUMMARY OF THE INVENTION

A magnet array having a collar, with a plurality of magnets attached to the inner surface of the collar. The magnets are positioned to have the same polarity facing toward the center of the collar; the identical polarity of the magnets combined with the circular shape efficiently maximizes the intensity of the magnet field. The magnets are also in a spaced alignment around the collar.

The design of the collar, made of high permeable material (steel), enhances magnetic flux lines toward the center of the collar thus adding magnetic strength toward the center and at the same time keeps magnetic flux leakage to a minimum toward the outside surfaces.

The number of permanent magnets and the space between the permanent magnets vary depending on applications and the diameters of the cylindrical collar. The cylindrical collar has a small open gap. This open gap provides flexibility to the cylindrical collar and allows the permanent magnet array to slide in easily into the engine oil filter. The function of the cylindrical collar is to enhance magnetic field toward the inner center of the cylindrical permanent magnet array and to shield magnetic flux leakage toward opposite to the center. The permanent magnet array device is coated with plastic for protection from corrosion.

### BRIEF DESCRIPTION OF THE DRAWINGS

FIG. 1 is a perspective view of a magnetic array fitted to an oil filter assembly;

FIG. 2 is a perspective view of a magnetic array;

FIG. 3 is a diagrammatic view of an array with the magnetic field generated by the magnetic members;

FIG. 4 is a side view of an alternative array with the magnetic field generated by the magnetic members; and

FIG. 5 is a perspective view of an alternative array.

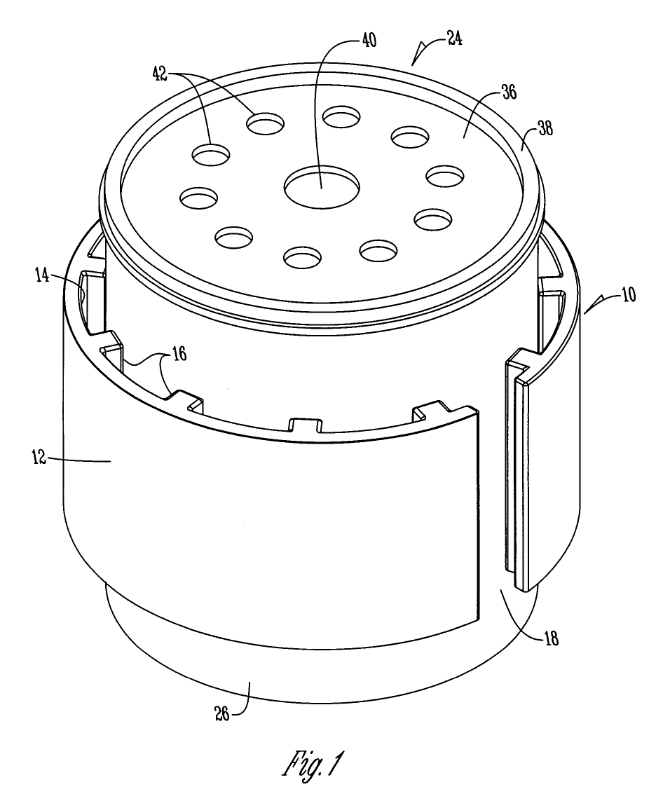

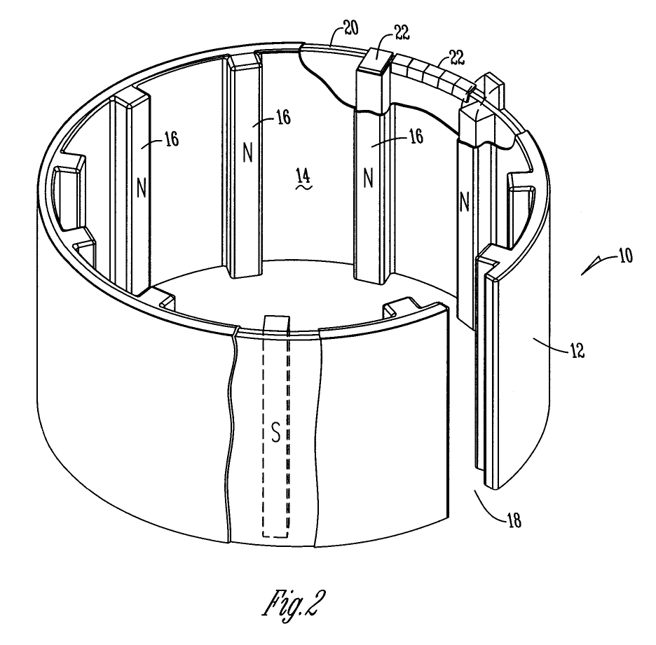

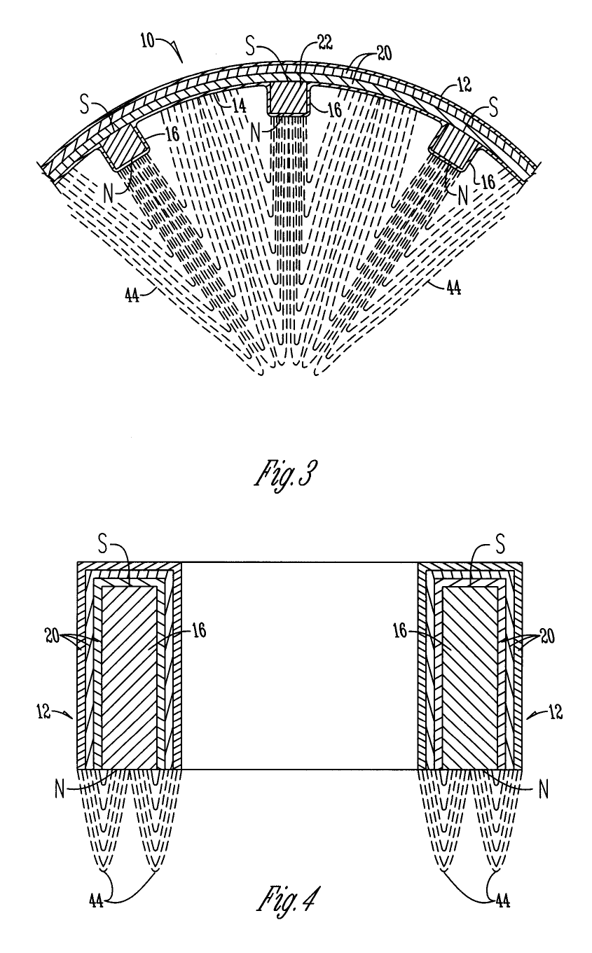

### DETAILED DESCRIPTION OF THE PREFERRED EMBODIMENTS

Referring to the Figures, a magnetic array 10 has a cylindrical collar 12 having an inner surface 14. Attached, in spaced relation, to the inner surface 14 of the collar 12 are a plurality of magnets 16.

The collar 12 is preferably made from a sheet of high permeability metal. The collar 12 is formed to create a gap 18 which provides the flexibility for mounting the collar 12 to objects of varying size. While the collar may be of a single piece, multiple sections having multiple gaps may also be used depending upon the application. Further, the collar 12 may be formed of a single sheet or multiple sheets depending upon the application.

The magnets 16 are mounted to the inner surface 14 of the collar 12 in spaced relation and are oriented such that the magnets all have a surface with the same polarity facing the center of the collar. The spacing between the magnets 16 enhances the magnetic field gradient. The spacing can be of a distance of natural repulsion or a pre-selected distance. The closer the magnets are to one another the stronger the magnetic field.

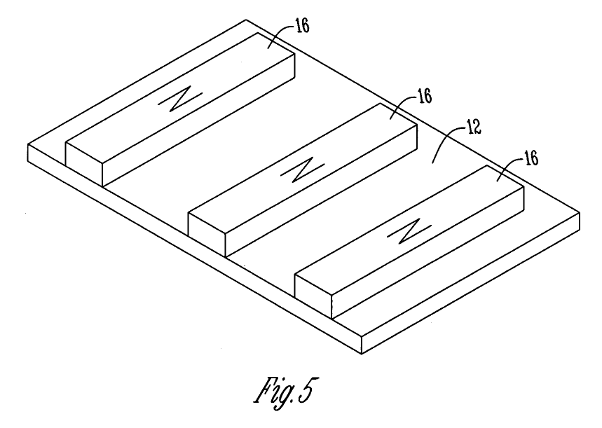

Alternatively, as shown in FIG. 4, depending on the application, the magnets 16 extend outwardly from the collar 12 with surfaces having the same polarity oriented upwardly and downwardly in relation to the collar. In another embodiment as shown in FIG. 5, the collar 12 is formed as a flat plate with the magnets attached thereto. Any type of magnet may be used, however, rare earth magnets of any type are preferred such as neodymium iron boron type magnet or in the alternative a sam arium cobalt type magnet may be used.

Shielding 20 from the collar 12 may be folded or formed around the magnets to increase the focus of the magnetic flux toward the center of the collar and reduce the magnetic field outside the shield. For example, portions 22 of the collar 12 are folded down over the ends of the magnets and the spacing between magnets. If multiple sheets are used to form the collar 12 additional portions are cut and folded such that they are not aligned with the magnet in order to eliminate air gaps for the magnetic field to escape. To protect the array from corrosion and moisture a plastic coating is formed over the array.

In operation, the array 10 is used with a variety of applications such as oil filters, bearings, and bearing sensors. In addition the array is used to attract or control iron nano-particles. For example, in bio medical applications such as where iron nano-particles are injected into cells that are combined with a chemical bonding agent that targets specific areas of the body. Some of these nano-particle agents have been used for thermal energy heating of targeted bodies such as tumors, chemotherapy, hypothermia, and drug packaging to target a region as in chemotherapy. Another application is for use in water treatment, filtering ferrous metal particles in water, separation of ferrous metal particles from oils and liquids in the magnetic particle inspection.

For purposes of illustration only, the array is described for use with a conventional oil filter assembly 24 having a cylindrical body 26. A filter 28 is contained within the body 26 and is generally cylindrical in shape and accordion-folded. The interior of the body 26 includes a hollow center core with a center shaft liner having a plurality of circular holes formed therein. A plurality of filter element vanes are made of a porous, fibrous material that allows the oil to pass through but traps larger foreign particles. A plate 36 is mounted on top of the body 26. The plate 36 includes a rubber seal 38 and a threaded opening 40 positioned in the center of the plate 36. The circular plate 36 also includes a number of circular openings 42 positioned radially outward from the threaded opening 40. The oil filter assembly 24 is generally threaded onto a suitable filter mount (not shown) located on the engine (not shown) in conventional fashion so that the engine's lubricating oil enters the assembly 26 through openings 42 to fill a region between the body 26 and the internal vanes of the filter.

The array 10 is slid over the body 26 of the filter assembly 24. The gap 18 and construction of the collar 12 create a spring loaded effect that provides the flexibility for the array 10 to fit bodies 26 of varying size. The magnets 16 mounted on the inner surface 14 of the collar 12 project a strong magnetic gradient that reaches the center of the array.

The magnetic force of the array is based on the formula
F=−M_{χ}VH·∇H
The magnetic force F directed toward a particle from the magnet is a product of the magnitude of the magnetic field H and the magnitude of the magnetic field gradient
∇H
where X is the magnetic susceptibility of the magnetic particle and V is the volume of the magnetic particle.

The magnets 16 generate a magnetic flux 44 that reaches the center of the array. Due to the high permeability sheets of the collar 12 the magnetic flux 44 at the outer surface of the outer surface of the array 10 stay close to the array 10.

What is claimed is:

1. A magnetic array for removing ferrous particles, comprising:
a collar having an inner surface;
a plurality of magnets attached to the inner surface of the collar, the magnets having the same polar surface facing a center of the cylindrical collar.

2. The array of claim 1 wherein the collar is made of a permeability sheet.

3. The array of claim 2 wherein the collar includes a plurality of sheets.

4. The array of claim 1 wherein the collar is interrupted to form a gap.

5. The array of claim 1 wherein the magnets are spaced apart from one another.

6. The array of claim 1 wherein the magnets are rare earth magnets.

7. The array of claim 1 wherein particles of the collar are folded over the magnets to provide shielding.

8. The array of claim 1 wherein the collar and the magnets are covered with a plastic coating.

9. A magnetic array for removing ferrous particles, comprising:
a collar having an inner surface,
a plurality of magnets attached to the inner surface of the collar, the magnets having the same polar surface facing a direction transverse to the inner surface of the collar.

10. The array of claim 9 wherein the collar is made of a permeability sheet.

11. The array of claim 10 wherein the collar includes a plurality of sheets.

12. The array of claim 9 wherein the collar is interrupted to form a gap.

13. The array of claim 9 wherein the magnets are spaced apart from one another.

14. The array of claim 9 wherein the magnets are rare earth magnets.

15. The array of claim 9 wherein particles of the collar are folded over the magnets to provide shielding.

16. The array of claim 9 wherein the collar and the magnets are covered with a plastic coating.

17. A magnetic array, comprising:
a flat collar;
a plurality of magnets attached to the collar having the same polar surface facing the collar.
